(19) United States
(12) Patent Application Publication
(10) Pub. No.: US 2018/0067531 A1
(43) Pub. Date: Mar. 8, 2018

(54) IMAGE PROCESSING APPARATUS, POWER SUPPLY METHOD, SCHEDULE UPDATE METHOD, AND COMPUTER PROGRAM

(71) Applicant: KONICA MINOLTA, INC., Tokyo (JP)

(72) Inventor: Tatsuya KITAGUCHI, Toyokawa-shi (JP)

(73) Assignee: KONICA MINOLTA, INC., Tokyo (JP)

(21) Appl. No.: 15/692,485

(22) Filed: Aug. 31, 2017

(30) Foreign Application Priority Data
Sep. 2, 2016 (JP) 2016-172008

(51) Int. Cl. G06F 1/32; G06T 1/20

(52) U.S. Cl. CPC G06F 1/32; G06T 1/20

(57) ABSTRACT

Provided is an image processing apparatus in which first schedule data defines a first on-time zone during which a power source is turned on and an off-time zone during which the power source is turned off, and that switches on and off of the power source for at least a part of hardware modules of the image processing apparatus on the basis of the first schedule data, and the image processing apparatus includes a hardware processor that: acquires second schedule data defining a second on-time zone during which a power source of another apparatus is turned on, from the other apparatus that performs processing in cooperation with the image processing apparatus; and updates the first schedule data such that the first on-time zone includes all or part of a time zone identical to the second on-time zone on the basis of the second schedule data.

Japanese Patent Application No. 2016-172008 filed on Sep. 2, 2016, including description, claims, drawings, and abstract the entire disclosure is incorporated herein by reference in its entirety.

### BACKGROUND

### Technological Field

The present invention relates to a power saving technique in an image processing apparatus such as an MFP.

### Description of the Related Art

In related art, a power saving method has been devised for various products. The power saving method has also been devised for a multi-functional image processing apparatus referred to as an “image forming apparatus”, a “multi function machine”, or a “multi function peripherals (MFP)”.

An image processing apparatus described in JP 2007-274487 A achieves power saving as follows. A network interface card (NIC) starts each function block in accordance with a predetermined weekly schedule. Thus, at times of low frequency of use such as nighttime or holidays, each function block that is another device is caused to be in a no energization state while the NIC is maintained in an energization state. Then, to determine update necessity of firmware held by a control unit even in a state of a sleep mode, the NIC executes processing of inquiring an information distribution server about presence of a version upgrade, and processing of responding to a request from an external host apparatus.

In recent years, in a facility such as a company, a government office, or a school, a plurality of image processing apparatuses may perform processing in cooperation with each other via a communication line.

In a case where two image processing apparatuses perform processing in cooperation with each other, a power source of one image processing apparatus may he turned off Hereupon, the other image processing apparatus cannot command processing until the power source of the one image processing apparatus is turned on.

Therefore, the following method has been devised. In a connection copy method of a copy machine network system including a connection copy function in which: a plurality of image forming apparatuses is connected together to be capable of communicating with each other; an arbitrary image forming apparatus to be a master unit reads a document to be copied, and supplies document information and connection instruction information to another image forming apparatus to he a slave unit; and the plurality of image forming apparatuses shares and executes in parallel the same copy processing from the same document, and in which at least the slave unit includes a weekly timer function that turns a main power source ON/OFF in accordance with ON/OFF times set for each day of the week, in a case where connection operation notification is given from the master unit to the slave unit that is not performing copy operation, the slave unit disables the weekly timer function in a period during which the connection operation notification is given (JP 2000-47536 A).

According to the method described in JP 2000-47536 A, since one apparatus (slave unit) is in a state in which the power source is turned on while the weekly timer function is disabled, the slave unit can promptly perform processing on the basis of a command from the other apparatus (master unit).

However, the slave unit may be in a state in which the power source is turned off before the connection operation notification is given. In this case, the master unit has to wait to issue a command for the slave unit until the power source is turned on and the system finishes starting in the slave unit.

### SUMMARY

In view of such a problem, an object of the present invention is to be able to provide a function of an image processing apparatus for another apparatus more promptly than before while achieving power saving.

To achieve the abovementioned object, according to an aspect of the present invention, there is provided an image processing apparatus in which first schedule data defines a first on-time zone during which a power source is turned on and an off-time zone during which the power source is turned off, and that switches on and oil of the power source for at least a part of hardware modules of the image processing apparatus on the basis of the first schedule data, and the image processing apparatus reflecting one aspect of the present invention comprises a hardware processor that: acquires second schedule data defining a second on-time zone during which a power source of another apparatus is turned on, from the other apparatus that performs processing in cooperation with the image processing apparatus; and updates the first schedule data such that the first on-time zone includes all or part of a time zone identical to the second on-time zone on the basis of the second schedule data.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an overall configuration of an image processing system;

FIG. 2 is a diagram illustrating an example of a hardware configuration of an image forming apparatus;

FIG. 3 is a diagram illustrating an example of access result data;

FIG. 4 is a diagram illustrating an example of job log data;

FIG. 5 is a diagram illustrating an example of a functional configuration of the image forming apparatus;

FIGS. 6A to 6C are diagrams each illustrating an example of schedule data and a schedule indicated in the corresponding schedule data;

FIG. 7 is a diagram illustrating an example of a schedule indicated in the schedule data after update;

FIG. 8 is a flowchart explaining an example of an overall processing flow in a master unit;

FIG. 9 is a flowchart explaining an example of an overall processing flow in a slave unit;

FIG. 10 is a flowchart explaining a modification of the overall processing flow in the master unit;

FIG. 11 is a diagram illustrating an example of the number of times of access from an image forming apparatus to a box of an image forming apparatus in a predetermined period;

FIG. 12 is a diagram illustrating an example of the number of times of access from an image forming apparatus to the box of the image forming apparatus in the predetermined period;

FIG. 13 is a diagram illustrating an example of the schedule indicated in the schedule data after update;

FIG. 14 is a diagram illustrating an example of the number of times of execution of a specific type job by an image forming apparatus (master unit) based on a command from an image forming apparatus (slave unit) in the predetermined period;

FIG. 15 is a diagram illustrating an example of the number of times of execution of the specific type job by the image forming apparatus (master unit) based on a command from an image forming apparatus (slave unit) in the predetermined period;

FIG. 16 is a diagram illustrating an example of the schedule indicated in the schedule data after update; and

FIG. 17 is a diagram illustrating an example of the schedule indicated in the schedule data after update.

### DETAILED DESCRIPTION OF EMBODIMENTS

Hereinafter, one or more embodiments of the present invention will be described with reference to the drawings. However, the scope of the invention is not limited to the disclosed embodiments.

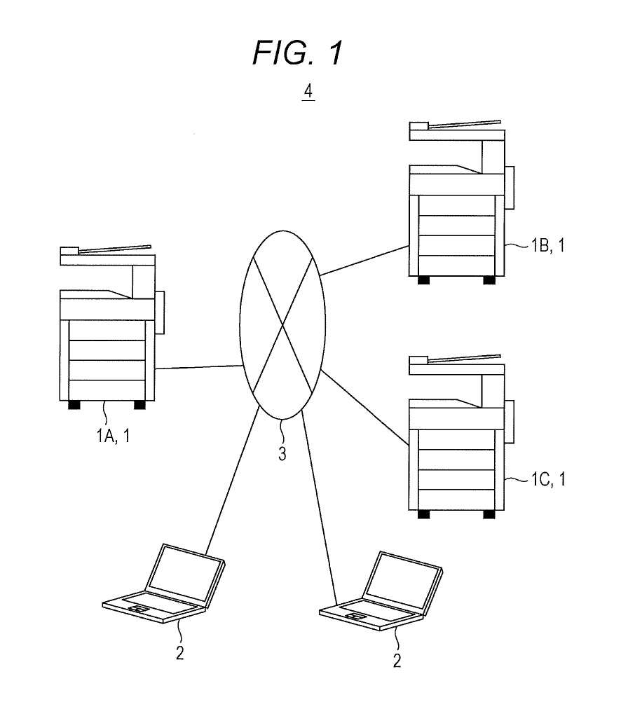

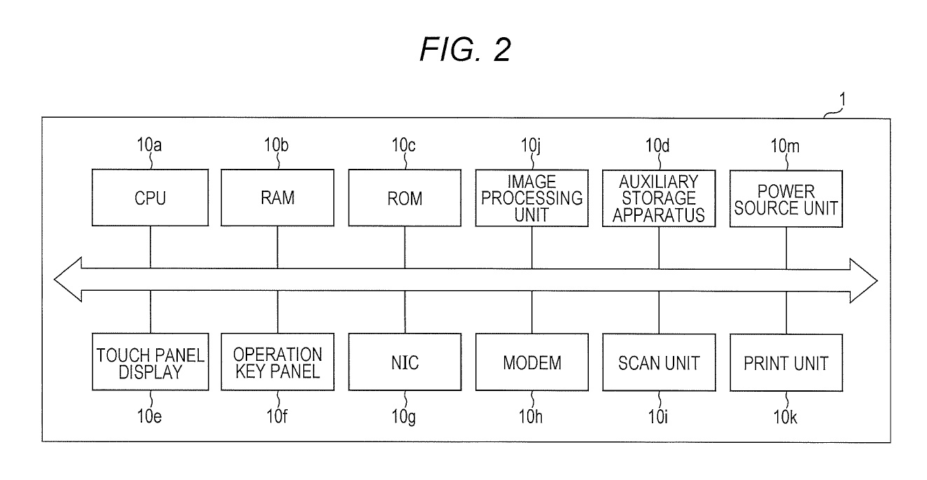

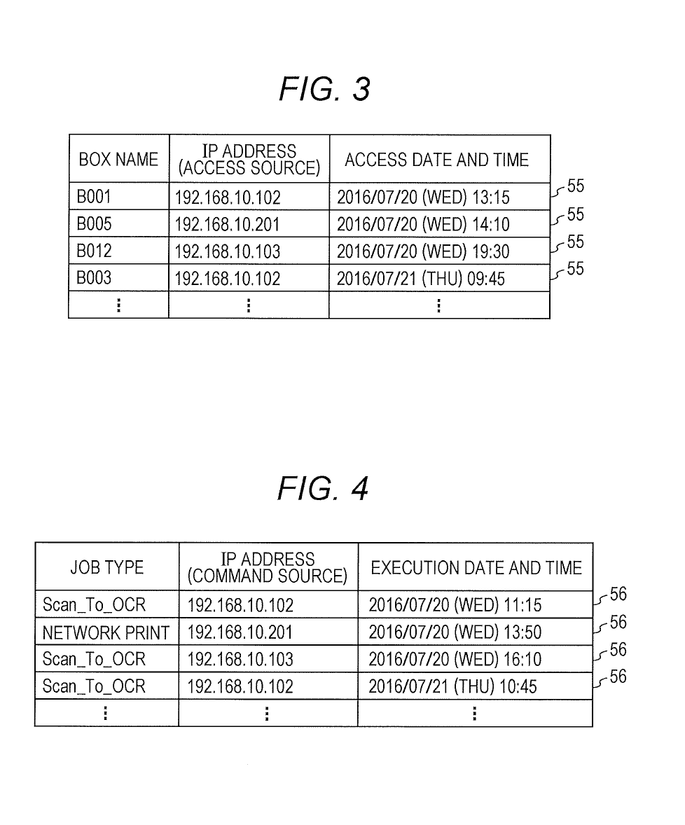

FIG. 1 is a diagram illustrating an example of an overall configuration of an image processing system 4. FIG. 2 is a diagram illustrating an example of a hardware configuration of an image forming apparatus 1. FIG. 3 is a diagram illustrating an example of access log data 55. FIG. 4 is a diagram illustrating an example of job log data 56.

The image processing system 4 includes a plurality of image forming apparatuses 1, a plurality of terminal apparatuses 2, and a communication line 3, as illustrated in FIG. 1.

The image forming apparatuses 1 and the terminal apparatuses 2 can communicate with each other via the communication line 3. As the communication line 3, a local area network (LAN) line, the Internet, a public line, or a dedicated line is used.

The image forming apparatus 1 is an apparatus in which functions are integrated, such as copy, network print, fax, scan, and box. In general, the image forming apparatus may be referred to as a “multi function machine” or a “multi-functional peripheral (MFP)”.

The box function is a function that gives a storage area referred to as a “box” or a “personal box” for each user and allows each user to store and manage document data such as an image file by the user's storage area. The box function may be referred to as a “server function” or a “file server function”. The box corresponds to a “folder” or a “directory” in a personal computer.

The user can remotely access the box from another apparatus (the terminal apparatus 2 or the other image forming apparatus 1), and can use the file stored in the box or store the file in the box.

Hereinafter, the image forming apparatuses 1 may be distinguished and described as an “image forming apparatus 1A”, an “image forming apparatus 1B”, an “image forming apparatus IC”, . . . .

The image forming apparatus 1A includes a function not included in the other image forming apparatus 1, and can provide the function for the other image forming apparatus 1.

For example, the image forming apparatus 1A includes an optical character recognition (OCR) function. The image forming apparatus 1B transmits image data scanned and generated by the image forming apparatus 1B, to the image forming apparatus 1A together with an OCR command. Hereupon, the image forming apparatus IA performs OCR processing to the image data to generate text data, and transmits the text data to the image forming apparatus 1B. Hereinafter, a job of the series of processing is described as “Scan_To_OCR”.

Further, the image forming apparatus 1A includes an authentication server function. The authentication server function is a function that authenticates an apparatus (the terminal apparatus 2 or the other image forming apparatus 1) trying to access the image forming apparatus 1A, or authenticates a user who uses the apparatus.

Hereinafter, the image forming apparatus 1 that provides the function is described as a “master unit”, and the image forming apparatus 1 for which the function is provided is described as a “slave unit”.

The image forming apparatus 1 includes a central processing unit (CPU) 10a, random access memory (RAM) 10b, read only memory (ROM) 10c, an auxiliary storage apparatus 10d, a touch panel display 10e, an operation key panel 10f, a network interface card (NIC) 10g, a modem 10h, a scan unit 10i, an image processing unit 10j, a print unit 10k, and a power source unit 10m, as illustrated in FIG. 2.

The touch panel display 10e displays a screen indicating a message to the user, a screen for the user to input a command or information, and a screen indicating a result of processing executed by the CPU 10a. In addition, the touch panel display 10e transmits a signal indicating a position touched, to the CPU 10a.

The operation key panel 10f is a so-called hardware keyboard, and includes a numeric keypad, a start key, a stop key, and a function key.

The NIC 10g communicates with the other image forming apparatus 1 or the terminal apparatus 2 via a protocol such as Transmission Control Protocol/Internet Protocol (TCP/IP). As the NIC 10g, a NIC compatible with Wake On LAN (WOL) is used.

The modem 10h exchanges image data with a facsimile terminal via a protocol such as G3.

The scan unit 10i reads an image drawn on a sheet set on a platen glass to generate image data.

The image processing unit 10j performs processing such as resolution conversion, inclination correction, vertical orientation correction, or rasterization, to the image data obtained by the NIC 10g, the modem 10h, or the scan unit 10i.

The print unit 10k prints the image on paper on the basis of the image data to which image processing is performed by the image processing unit 10j.

The power source unit 10m supplies power to hardware modules of the image forming apparatus 1 exemplified above.

The ROM 10c or the auxiliary storage apparatus 10d stores a program for realizing functions such as the above-described copy and network print, besides a basic input/output system (BIOS). Further, the image forming apparatus 1 that can be a master unit stores a master unit program 10P. The image forming apparatus 1 that can be a slave unit stores a slave unit program 10Q. The master unit program 10P and the slave unit program 10Q are both programs for switching on/off of a power source on the basis of a schedule.

These programs are loaded on the RAM 10b, and executed by the CPU 10a. As the auxiliary storage apparatus 10d, a hard disk or a solid state drive (SSD) is used.

The BIOS includes a timer start function. The “timer start function” is a function that automatically turns on the power source when it is a date and time specified (hereinafter, referred to as “specified date and time”). The function may also be referred to a “Wake On RTC Timer”, an “automatic start function”, or a “weekly timer”. However, some image forming apparatuses 1 do not include the timer start function, the master unit program 10P, or the slave unit program 10Q.

Hereinafter, processing by the master unit program 10P and processing by the slave unit program 10Q will be described in a case where the image forming apparatus 1A is the master unit, and the image forming apparatuses 1 other than the image forming apparatus 1A are slave units, as an example. The image forming apparatus 1A includes the timer start function and the master unit program 10P. Out of the image forming apparatuses 1 other than the image forming apparatus 1A, at least the image forming apparatuses 1B and 1C include the timer start function and the slave unit program 10Q.

In addition, the auxiliary storage apparatus 10d stores a result of access to the box provided in the image forming apparatus 1 as the access log data 55. Specifically, for each time when the box is accessed, as illustrated in FIG. 3, the auxiliary storage apparatus 10d stores data indicating an identifier of the box, an identifier of the apparatus that is an access source (the image forming apparatus 1 or the terminal apparatus 2), and a date and time accessed, as the access log data 55. As the identifier of the box, for example, a box name is used. In addition, as the identifier of the apparatus, an IP address is used.

Further, the auxiliary storage apparatus 10d stores a result of execution of a job in the image forming apparatus 1 as the job log data 56. Specifically, for each time when the job is executed in the image forming apparatus 1, as illustrated in FIG. 4, the auxiliary storage apparatus 10d stores data indicating a type of the job, an identifier of the apparatus that is a command source of the job (the image forming apparatus 1 or the terminal apparatus 2), and a date and time when the job is executed, as the job log data 56.

In this way, the auxiliary storage apparatus 10d accumulates a history of access to the box and a history of execution of the job.

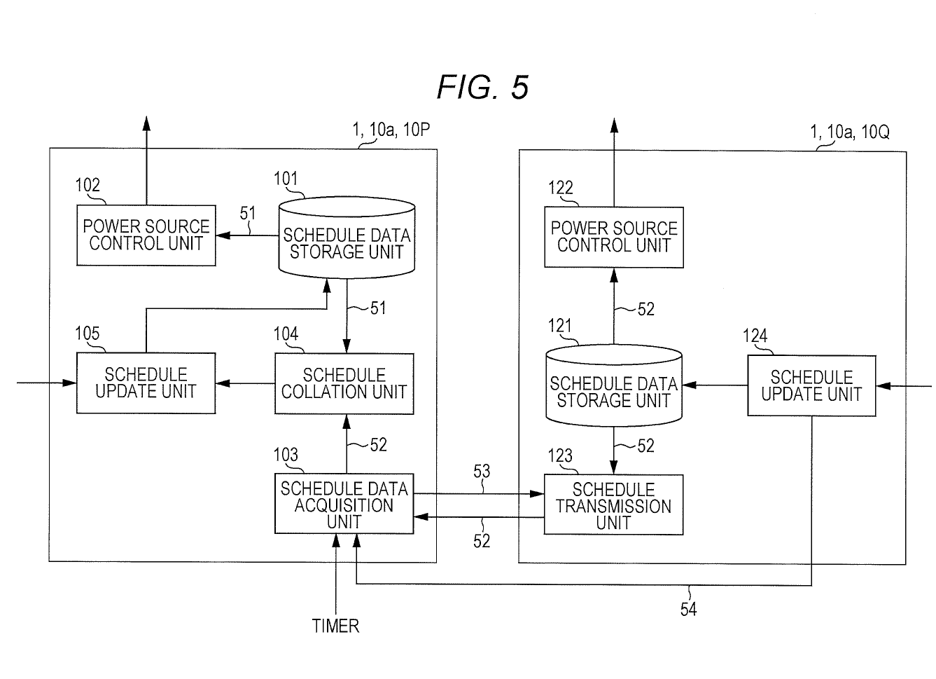

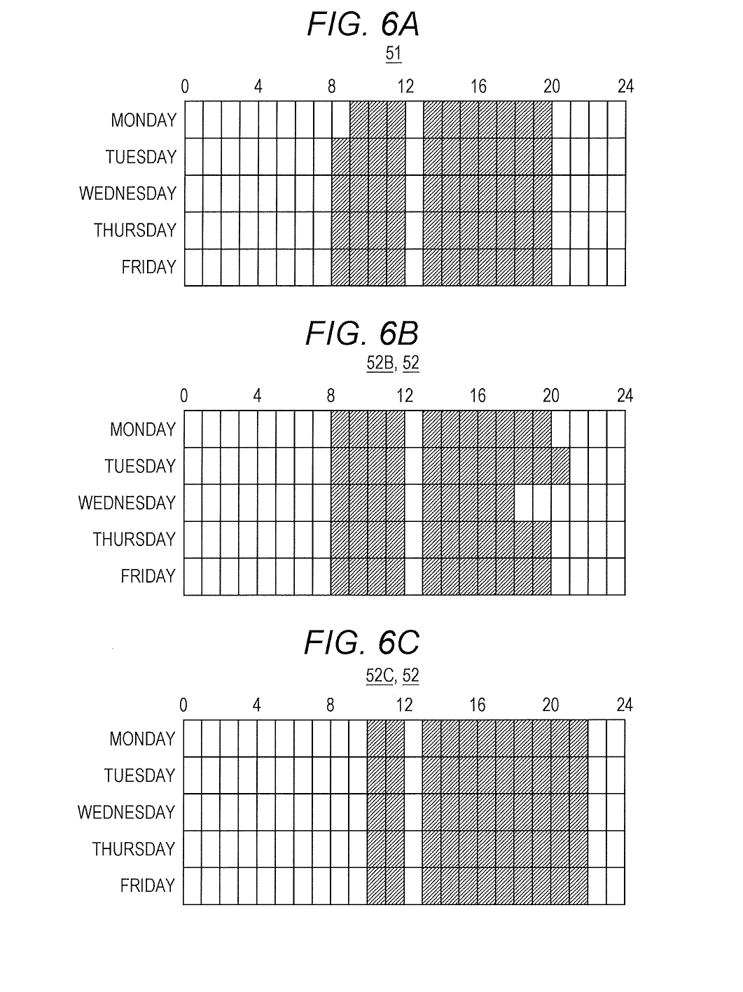

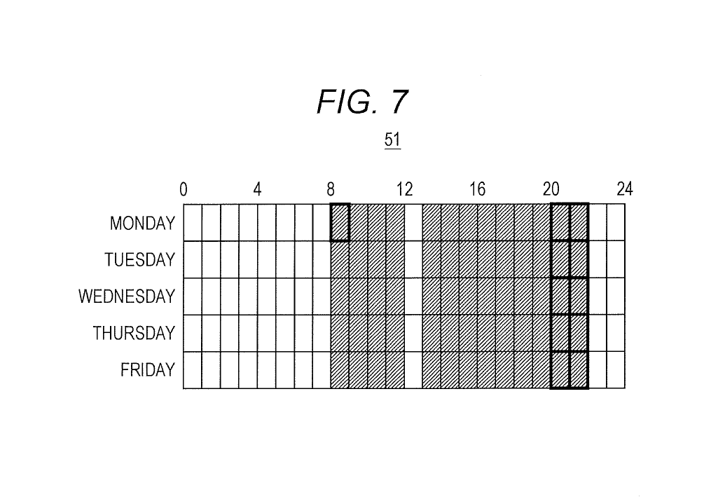

FIG. 5 is a diagram illustrating an example of a functional configuration of the image forming apparatus 1. FIGS. 6A to 6C are diagrams each illustrating an example of a schedule indicated in the corresponding schedule data 51 or schedule data 52. FIG. 7 is a diagram illustrating an example of a schedule indicated in the schedule data 51 after update.

The master unit program 10P realizes a schedule data storage unit 101, a power source control unit 102, a schedule data acquisition unit 103, a schedule collation unit 104, and a schedule update unit 105 illustrated in FIG. 5.

The slave unit program 10Q realizes a schedule data storage unit 121, a power source control unit 122, a schedule transmission unit 123, and a schedule update unit 124.

The schedule data storage unit 101 of the image forming apparatus 1A stores the schedule data 51.

The schedule data 51 indicates a schedule for on/off of the power source of the image forming apparatus IA itself Specifically, the schedule data 51 indicates the schedule of the power source of the image forming apparatus 1A itself hourly on each week day, that is, from Monday to Friday, as illustrated in FIG. 6A. The gray time zone represents a time zone during which the power source is turned on, and the white time zone represents a time zone during which the power source is turned off.

Hereinafter, the time zone during which the power source is turned on is described as an “on-time zone”, and the time zone during which the power source is turned off is described as an “off-time zone”. In the present embodiment, on Saturday and Sunday, in all the image forming apparatuses 1, all time zones (that is, all day) are off-time zones.

The schedule data storage unit 121 of each of the image forming apparatuses 1B, 1C, . . . stores the schedule data 52. Hereinafter, the schedule data 52 of each of the image forming apparatuses 1B, 1C, . . . may be distinguished and described as “schedule data 52B”, “schedule data 52C”, . . . .

The schedule data 52 indicates a schedule for on/off of the power source of each of the image forming apparatuses 1B, 1C, For example, the schedule data 52 of the image forming apparatus 1B (the schedule data 52B) indicates a schedule of a power source of the image forming apparatus 1B hourly on each day from Monday to Friday, as illustrated in FIG. 6B. Alternatively, the schedule data 52 of the image forming apparatus 1C (the schedule data 52C) indicates a schedule of a power source of the image forming apparatus 1C hourly on each day from Monday to Friday, as illustrated in FIG. 6C.

In the image forming apparatus 1A, on the basis of the schedule data 51 and the like, the power source control unit 102 controls on/off of the power source of the image forming apparatus 1A itself as follows.

In a state in which the power source is turned on, when the time zone is the off-time zone, the power source control unit 102 sets a start time of the next on-time as a specified time in the BIOS. Then, the power source control unit 102 commands the power source unit 10m to turn off the power source of the image forming apparatus 1A itself. Hereupon, the power source of the image forming apparatus 1A itself is turned off by the power source unit 10m. Specifically, supply of power is stopped to the CPU 10a, the RAM 10b, the ROM 10c, the auxiliary storage apparatus 10d, the touch panel display 10e, the operation key panel 10f, the scan unit 10i, the image processing unit 10j, and the print unit 10k. After that, when it is the specified time, the power source of the image forming apparatus 1A itself is turned on by the power source unit 10m.

For example, when it is 12:00 (noon) on Wednesday, Jul. 20, 2016, the power source control unit 102 sets 13:00 on the same day as the specified time in the BIOS. Then, the power source control unit 102 commands the power source unit 10m to turn off the power source of the image forming apparatus 1A itself. Alternatively, when it is 20:00 on Friday, Jul. 22, 2016, the power source control unit 102 sets 8:00 on Monday, Jul. 25, 2016 as the specified time in the BIOS. Then, the power source control unit 102 commands the power source unit 10m to turn off the power source of the image forming apparatus 1A itself.

After that, when it is the specified time, the power source is turned on by the BIOS, the power source unit 10m, and the like, and a system of the image forming apparatus 1A (for example, an operating system) is started, and the master unit program 10P is also started.

In addition, in the image forming apparatus 1A, also in a case where a magic packet is transmitted from the terminal apparatus 2 or the other image forming apparatus 1, the power source is turned on by the BIOS, the power source unit 10m, and the like. Then, the job is executed on the basis of the data received after that, as appropriate.

After execution of the job, in a case where a predetermined time (for example, five minutes) elapses without receiving the data of the other job and without any operation by the user, if the time is the off-time zone, the power source control unit 102 sets the specified time in the BIOS as described above, and causes the power source unit 10m to turn off the power source.

The power source control units 122 of the respective image forming apparatuses 1B, 1C, . . . control on/off of the power sources of the image forming apparatuses 1B, 1C, . . . themselves on the basis of the schedule data 52 of the respective image forming apparatuses 1B, 1C, . . . . For example, the power source control unit 122 of the image forming apparatus 1B controls on/off of the power source of the image forming apparatus 1B itself on the basis of the schedule data 52B (see FIG. 6B). How to control is similar to how to control on/off of the power source by the power source control unit 102 in the image forming apparatus 1A.

In the image forming apparatus 1A, the schedule data acquisition unit 103, the schedule collation unit 104, and the schedule update unit 105 execute processing of rewriting the schedule data 51 of the image forming apparatus 1A itself at a predetermined time (for example, every Friday at 16:00), as follows. The predetermined time is desirably a day of the week and time in the on-time zone in all image forming apparatuses 1.

The schedule data acquisition unit 103 requests the schedule data 52 from the image forming apparatuses 1B, 1C, . . . and acquires the data. When requesting, the schedule data acquisition unit 103 transmits request data 53 to the image forming apparatuses 1B, 1C, . . . . Before transmitting the request data 53, the schedule data acquisition unit 103 may transmit the magic packet to the image forming apparatuses 1B, 1C, . . . .

In each of the image forming apparatuses 1B, 1C, . . . , when receiving the request data 53 from the image forming apparatus 1A, the schedule transmission unit 123 reads the schedule data 52 of the image processing apparatus from the schedule data storage unit 121, and transmits the data to the image forming apparatus 1A. Due to the fact that the power source is turned off the slave unit program 10Q or the timer start ftmction is not included, communication failure occurs, or the slave unit program 10Q is not started, there is a case where the schedule data 52 cannot be transmitted to the image forming apparatus 1A.

In the image forming apparatus 1A, in a case where a predetermined time (for example, one minute) elapses after the request data 53 is transmitted, the schedule collation unit 104 collates the schedule indicated in the schedule data 51 with the schedule indicated in the corresponding schedule data 52 acquired by the schedule data acquisition unit 103 by the time when the predetermined time elapses. Then, a time zone is extracted that is the off-time zone in the image forming apparatus 1A and is the on-time zone in any of the image forming apparatuses 1B, 1C, . . . .

For example, it is assumed that the schedule data 52B and 52C are acquired from the respective image forming apparatuses 1B and 1C by the schedule data acquisition unit 103, but the schedule data 52 is not acquired from the image forming apparatuses 1 other than the image forming apparatuses 1B and 1C. In this case, the schedule collation unit 104 collates (compares) the schedule indicated in the schedule data 51 with the schedule indicated in each of the schedule data 52B and the schedule data 52C.

Hereupon, it is found that the time zone of 8:00-9:00 on Monday is the off-time zone in the image forming apparatus 1A but is the on-time zone in the image forming apparatus 1B. In addition, it is found that the time zone of 20:00-21:00 and the time zone of 21:00-22:00 on each day from Monday to Friday are the off-time zones in the image forming apparatus 1A but are the on-time zones in the image forming apparatus 1C.

Therefore, the schedule collation unit 104 extracts the time zone of 8:00-9:00 on Monday, and the time zone of 20:00-21:00 and the time zone of 21:00-22:00 on each day from Monday to Friday.

Incidentally, the schedule collation unit 104 regards that a time zone is always the off-time zone in the image forming apparatuses 1 not transmitting the schedule data 52 to the image forming apparatus 1A. That is, data is generated indicating that the time zone is always the off-time zone, and collation is performed assuming that the data are received as the schedule data 52 from these image forming apparatuses 1.

The schedule update unit 105 updates the schedule data 51 such that the time zone extracted by the schedule collation unit 104 is the on-time zone. In a case of examples of the above-described FIGS. 6A to 6C, as indicated by thick frames in FIG. 7, update is performed such that the time zone of 8:00-9:00 on Monday, and the time zones of 20:00-21:00 and 21:00-22:00 on each day from Monday to Friday are the on-time zones.

In each of the image forming apparatuses 1B, 1C, . . . , the schedule update unit 124 updates the schedule data 52 of the image processing apparatus such that the on-time zone and the off-time zone are changed in accordance with user's operation.

For example, in the image forming apparatus 1B, when operation is performed to change the time zone of 12:00-13:00 on Monday to the on-time zone, the schedule update unit 124 updates the schedule data 52B such that the time zone of 12:00-13:00 on Monday is the on-time zone.

In the image forming apparatus 1A, the schedule update unit 105 updates the schedule data 51 such that the on-time zone and the off-time zone are changed in accordance with user's operation, similarly to the schedule update unit 124.

Incidentally, the schedule data acquisition unit 103 performs processing of acquiring the schedule data 52 from each of the image forming apparatuses 1B, 1C, . . . when a predetermined time comes. However, the processing may be performed when the schedule data 52 is updated in any of the image forming apparatuses 1B, 1C, . . . .

In this case, the schedule update unit 124 of each of the image forming apparatuses 1B, 1C, . . . transmits update notification data 54 to the image forming apparatus 1A when the schedule data 52 of the image processing apparatus is updated.

Then, in the image forming apparatus 1A, the schedule data acquisition unit 103 transmits the request data 53 to the image forming apparatuses 1B, 1C, . . . at timing when the update notification data 54 is received. The schedule collation unit 104 and the schedule update unit 105 collates the schedule of the image forming apparatus 1A with the schedules of the other image forming apparatuses 1 by the above-described method, and updates the schedule data 51 in accordance with the result.

Incidentally, instead of the update notification data 54, the schedule data 52 updated may be transmitted to the image forming apparatus 1A by the schedule transmission unit 123.

In this case, the schedule collation unit 104 only needs to collate the schedule indicated in the schedule data 51 with only the schedule indicated in the schedule data 52. Then, the schedule update unit 105 only needs to update the schedule data 51 such that a time zone that is the on-time zone in the latter but is the off-time zone in the former is the on-time zone.

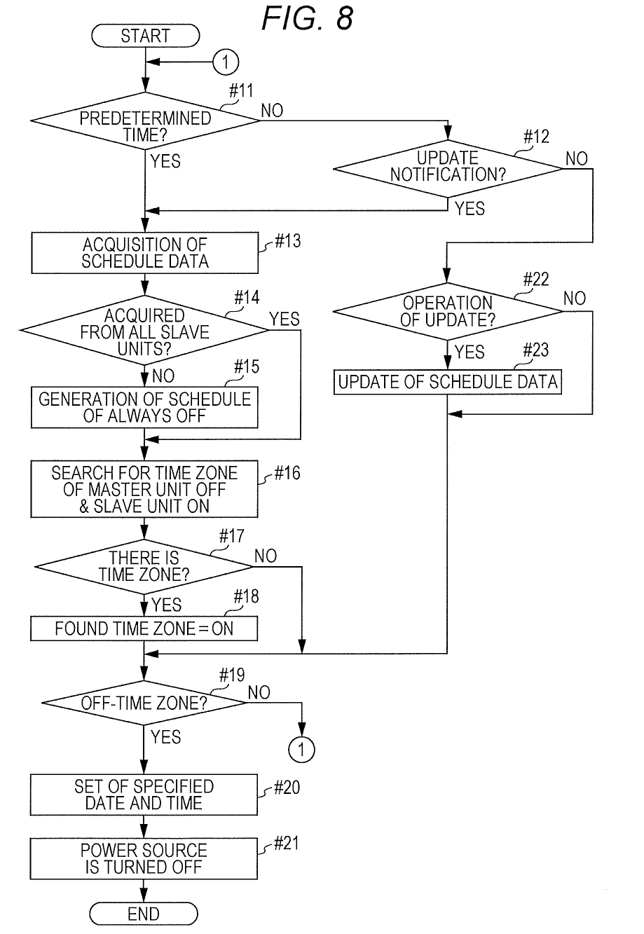

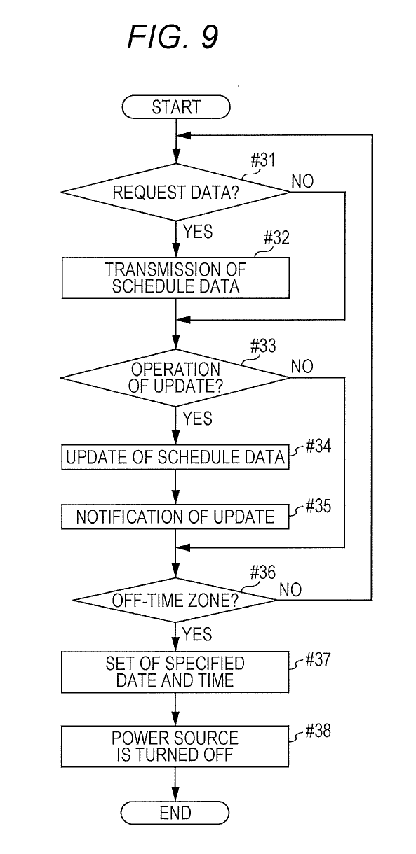

FIG. 8 is a flowchart explaining an example of an overall processing flow in the master unit. FIG. 9 is a flowchart explaining an example of an overall processing flow in the slave unit.

Next, an overall processing flow regarding update of the schedule data 51 will be described with reference to a flowchart in a case where the image forming apparatus 1A is the master unit and the other image forming apparatuses 1 are slave units, as an example.

The image forming apparatus 1A executes processing in a procedure illustrated in FIG. 8 on the basis of the master unit program 10P. In addition, the image forming apparatuses 1 other than the image forming apparatus 1A execute processing in a procedure illustrated in FIG. 9 on the basis of the slave unit program 10Q.

When it is a predetermined time (Yes in #11 of FIG. 8), the image forming apparatus 1A executes processing of updating the schedule data 51 as follows (#13 to #18).

The image forming apparatus 1A transmits the request data 53 to the other image forming apparatuses 1, thereby requesting and acquiring the schedule data 52 (#13).

In a case where there is another image forming apparatus 1 not transmitting the schedule data 52 by the time when a predetermined time elapses (No in #14), the image forming apparatus 1A generates data indicating that the time zone is always the off-time zone as the schedule data 52 of the other image forming apparatus 1 (#15).

The image forming apparatus 1A collates the schedule of the image forming apparatus 1A indicated in the schedule data 51 with the schedule indicated in the corresponding schedule data 52 acquired in step #13 or generated in step #15, thereby extracting the time zone that is the off-time zone in the image forming apparatus 1A but is the on-time zone in any of the image forming apparatuses 1B, 1C, . . . (#16).

In a case where the time zone can be extracted (Yes in #17), the image forming apparatus 1A updates the schedule data 51 such that the time zone extracted is the on-time zone (#18). In a case where the time zone cannot be extracted (No in #17), the schedule data 51 is not updated.

The image forming apparatus 1A, when the current date and time is the off-time indicated in the schedule data 51 (Yes in #19), sets the date and time of the start of the next on-time zone as the specified date and time in the BIOS (#20). Then, the power source is turned off (#21).

After that, when it is the specified time, the image forming apparatus 1A turns on the power source, and starts the system, the master unit program 10P, and the like.

Meanwhile, the image forming apparatuses 1 other than the image forming apparatus 1A, when receiving the request data 53 from the image forming apparatus 1A (Yes in #31 of FIG. 9), transmit the schedule data 52 of the image processing apparatuses to the image forming apparatus 1A (#32). Alternatively, the image forming apparatuses 1, when the user performs operation of updating the schedule data 52 (Yes in #33), update the schedule data 52 of the image processing apparatuses in accordance with the operation (#34), and transmit the update notification data 54 to the image forming apparatus 1A (#35). Instead of the update notification data 54, the schedule data 52 after update may be transmitted. In addition, the image forming apparatuses 1, when the current date and time is the off-time indicated in the schedule data 51 (Yes in #36), sets the date and time of the start of the next on-time zone as the specified date and time in the BIOS (#37). Then, the power source is turned off (#38). After that, when it is the specified time, the power source is turned on, and the system, the slave unit program 10Q, and the like are started.

The image forming apparatus 1A, when receiving the update notification data 54 from the other image forming apparatuses 1 (Yes in #12), similarly to the case where it is the predetermined time, executes the processing of updating the schedule data 51 (#13 to #18).

Incidentally, in a case where the schedule data 52 is transmitted instead of the update notification data 54, the image forming apparatus 1A only needs to execute the processing of steps #16 to#18 on the basis of the schedule data 51 of the image forming apparatus 1A itself and the schedule data 52.

Besides, the image forming apparatus 1A, when the user performs operation of updating the schedule data 51 (Yes in #22), updates the schedule data 51 in accordance with the operation (#23).

According to the present embodiment, it is possible to provide the function of the image forming apparatus 1A for the other image forming apparatuses 1 (1B, 1C, . . . ) more promptly than before while achieving power saving of the image forming apparatus 1A.

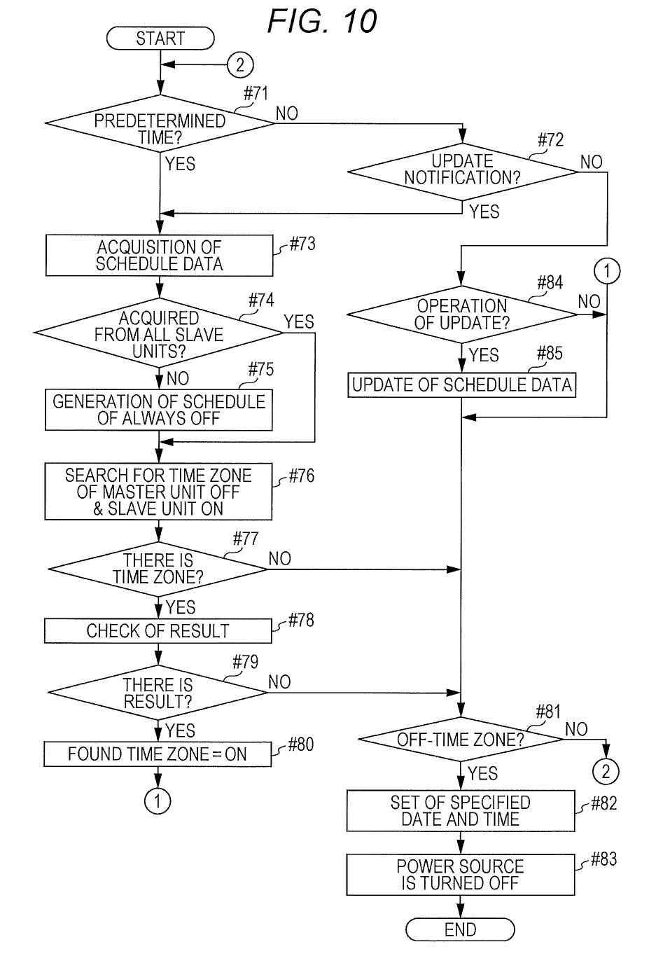

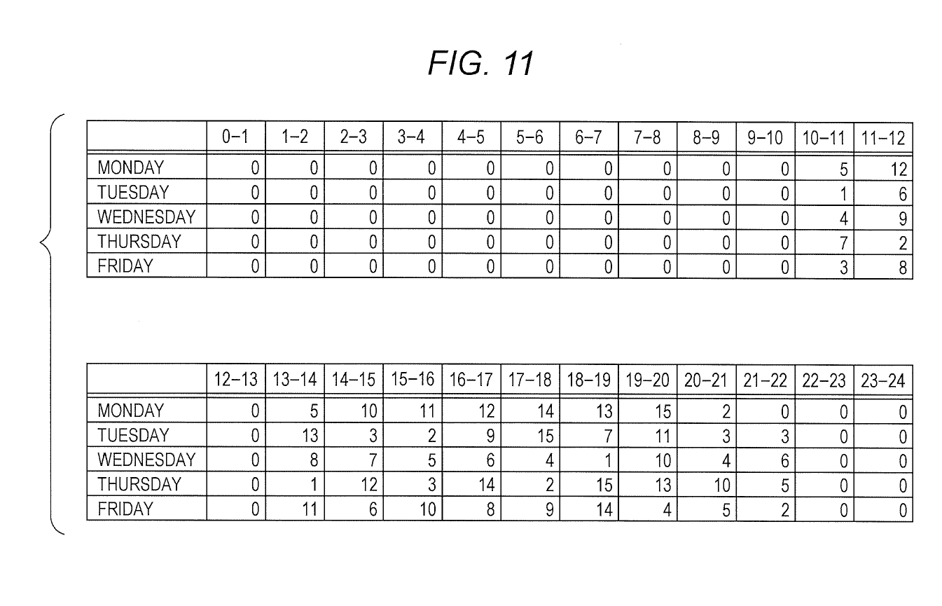

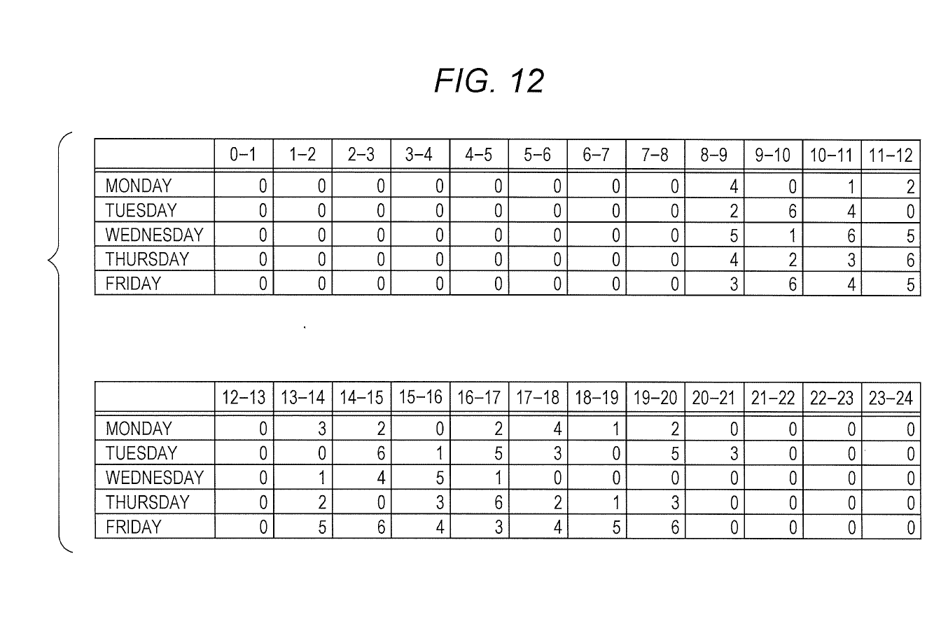

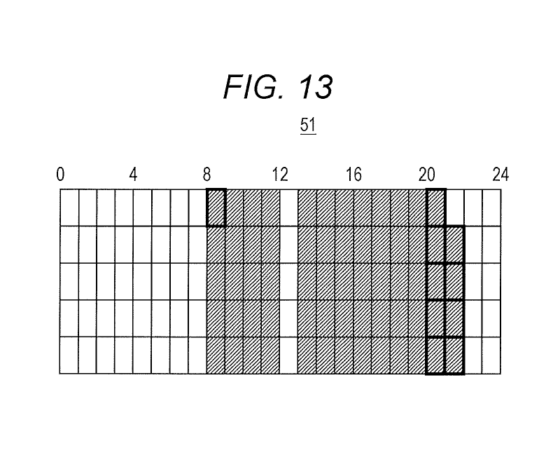

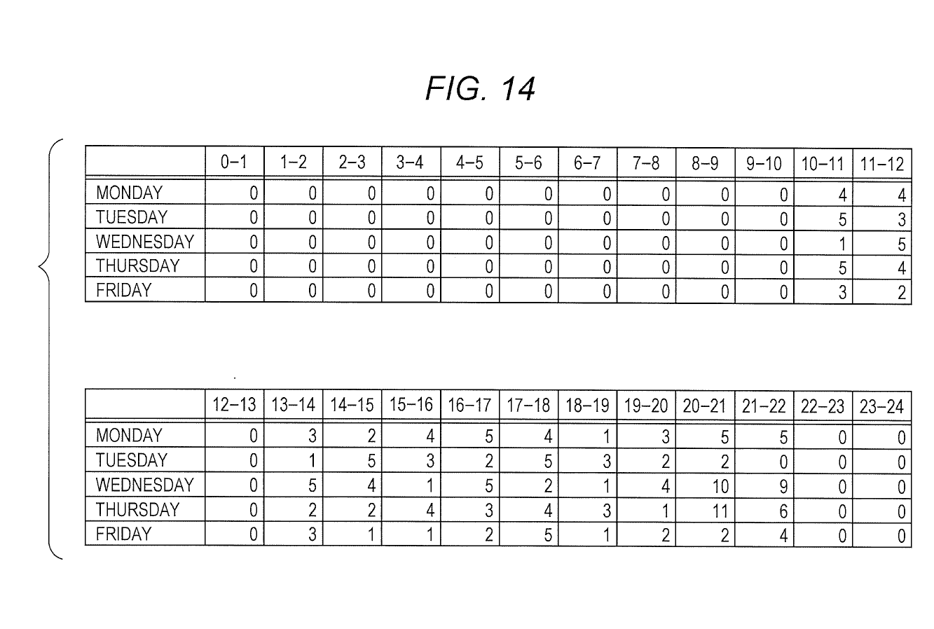

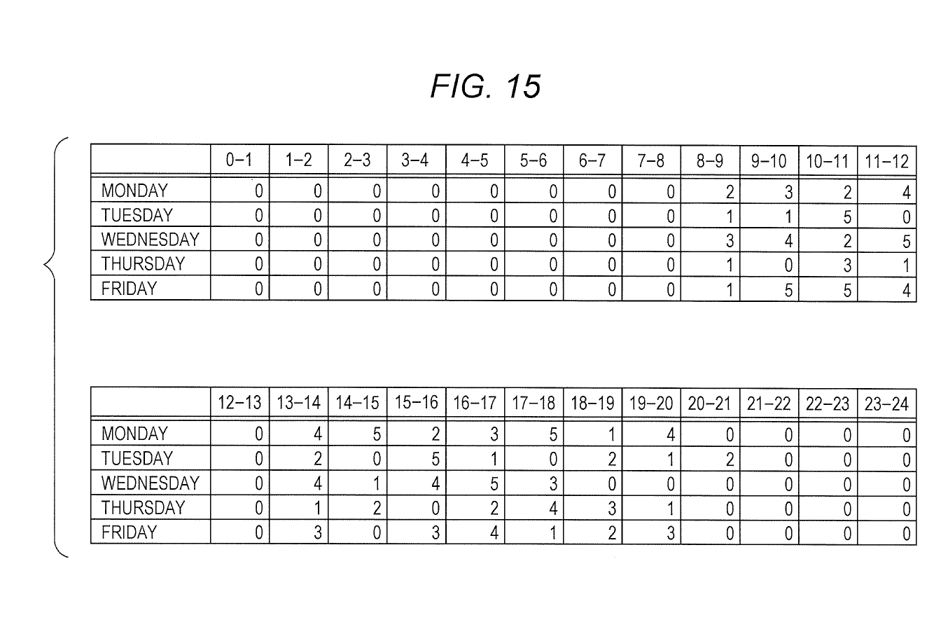

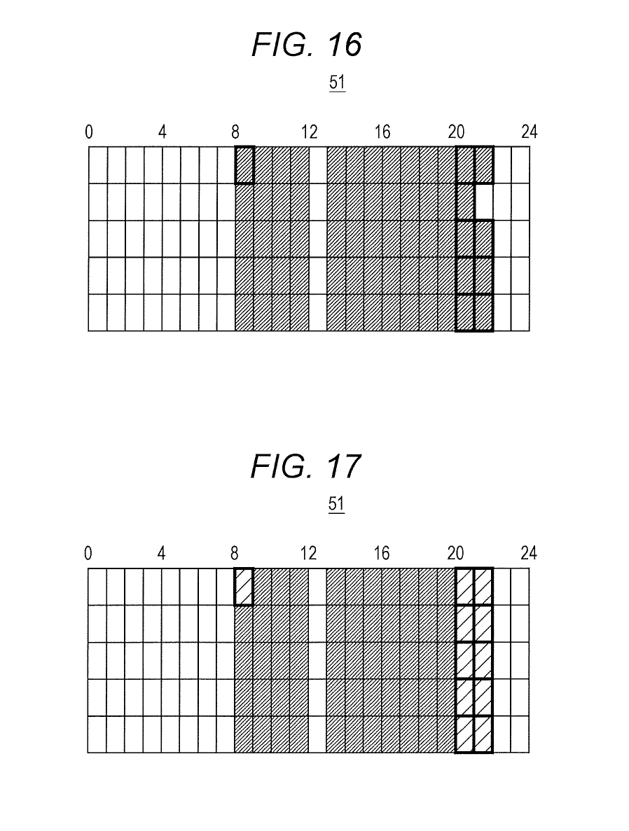

FIG. 10 is a flowchart explaining a modification of the overall processing flow in the master unit. FIG. 11 is a diagram illustrating an example of the number of times of access from the image forming apparatus 1B to the box of the image forming apparatus 1A in a predetermined period. FIG. 12 is a diagram illustrating an example of the number of times of access from the image forming apparatus 1C to the box of the image forming apparatus 1A in the predetermined period. FIG. 13 is a diagram illustrating an example of the schedule indicated in the schedule data 51 after update. FIG. 14 is a diagram illustrating an example of the number of times of execution of a specific type job by the image forming apparatus 1A (master unit) based on a command from the image forming apparatus 1B (slave unit) in the predetermined period. FIG. 15 is a diagram illustrating an example of the number of times of execution of the specific type job by the image forming apparatus 1A (master unit) based on a command from the image forming apparatus 1C (slave unit) in the predetermined period. FIG. 16 is a diagram illustrating an example of the schedule indicated in the schedule data 51 after update. FIG. 17 is a diagram illustrating an example of the schedule indicated in the schedule data 51 after update.

In the present embodiment, the image forming apparatus 1A extracts the time zone that is the off-time zone in the image forming apparatus 1A but is the on-time zone in any of the image forming apparatuses 1B, 1C, . . . . Then, regardless of other conditions, the schedule data 51 is updated such that the time zone extracted is the on-time zone. However, the schedule data 51 may be updated in a procedure illustrated in FIG. 10.

The processing of steps #71 to #75, the processing of steps #81 to #83, and the processing of steps #84 to #85 in FIG. 10 are similar to the processing of steps #11 to #15, the processing of steps #19 to #21, and the processing of steps #22 to #23 in FIG. 8, respectively.

The schedule collation unit 104 extracts a time zone (hereinafter, referred to as a “candidate time zone”) that is the off-time zone in the image forming apparatus 1A but is the on-time zone in any of the image forming apparatuses 1B, 1C, . . . , similarly to step #16 of FIG. 8 (#76).

The schedule update unit 105, when the candidate time zone is extracted (Yes in #77), checks whether or not there is access to the box of a predetermined number of times or more during a past predetermined period (for example, the most recent one-month period) in the candidate time zone on the basis of the access log data 55 (see FIG. 3) (#78).

Then, in a case where there is access to the box of the predetermined number of times or more during the predetermined period (Yes in #79), the schedule update unit 105 updates the schedule data 51 such that the candidate time zone is the on-time zone (#80). Otherwise (No in #79), update is not performed.

In a case where multiple candidate time zones are extracted in step #76, the schedule update unit 105 executes processing of steps #78 to #80 for each of the candidate time zones.

For example, it is assumed that the number of times of access to the box during the predetermined period from each of the image forming apparatuses 1B and 1C is as illustrated in FIGS. 11 and 12, and the time zone of 8:00-9:00 on Monday, and the time zone of 20:00-21:00 and the time zone of 21:00-22:00 on each day from Monday to Friday (time zones indicated by thick frames in FIG. 7) are extracted as the candidate time zones. Then, it is assumed that the predetermined number of times is “once”.

In this case, for only the time zone of 21:00-22:00 on Monday out of the candidate time zones, the number of times of access does not reach the predetermined number of times. Accordingly, the schedule update unit 105 updates the schedule data 51 such that the candidate time zones other than the time zone of 21:00-22:00 on Monday out of the candidate time zones are the on-time, as illustrated in FIG. 13.

Alternatively, instead of the number of times of access to the box, the number of times of authentication of the other apparatuses or their users may be recorded, and necessity of update of the schedule data 51 may be determined on the basis of the number of times.

Alternatively, in step #78, the schedule update unit 105 checks whether or not the specific type job (for example, Scan_To_OCR job) is executed a predetermined number of times or more during the candidate time zone in a past predetermined period on the basis of the job log data 56 (see FIG. 4).

Then, in a case where the specific type job is executed the predetermined number of times or more during the predetermined period (Yes in #79), the schedule update unit 105 updates the schedule data 51 such that the candidate time zone is the on-time zone (#80). Otherwise (No in #79), update is not performed. In a case where multiple candidate time zones are extracted in step #76, the schedule update unit 105 executes processing of steps #78 to #80 for each of the candidate time zones.

For example, it is assumed that the number of times of execution of the specific job during the predetermined period based on the command from each of the image forming apparatuses 1B and 1C is as illustrated in FIGS. 14 and 15, and the time zone of 8:00-9:00 on Monday, and the time zone of 20:00-21:00 and the time zone of 21:00-22:00 on each day from Monday to Friday (time zones indicated by thick frames in FIG. 7) are extracted as the candidate time zones. Then, it is assumed that the predetermined number of times is “once”.

In this case, for only the time zone of 21:00-22:00 on Tuesday, the number of times of access does not reach the predetermined number of times. Accordingly, the schedule update unit 105 updates the schedule data 51 such that the candidate time zones other than the time zone of 21:00-22:00 on Tuesday out of the candidate time zones are the on-time, as illustrated in FIG. 16.

Incidentally, in step #78, the schedule update unit 105 may check whether or not the number of times of access from only the image forming apparatus 1 in which the candidate time zones are the on-time zone is the predetermined number of times or more. Alternatively, the schedule update unit 105 may check whether or not the number of times of execution of only the specific job based on the command from the image forming apparatus 1 in which the candidate time zones are the on-time zones is the predetermined number of times or more.

In the present embodiment, the power source control units 102 and 122 cause the power source unit 10m to stop supplying power to the CPU 10a, the RAM 10b, the ROM 10c, the auxiliary storage apparatus 10d, the touch panel display 10e, the operation key panel 10f, the scan unit 10i, the image processing unit 10j, and the print unit 10k, thereby turning off the power source. That is, the system of the image forming apparatus 1 is shut down.

However, instead of being shut down, the image forming apparatus 1 may be set to a power saving mode such as a sleep mode. In this case, the specified date and time are not written in the BIOS. Instead, the power source control units 102 and 122 cause the power source unit 10m to release the power saving mode when it is the on-time zone, thereby returning the system to the normal power mode.

In the present embodiment, processing of the server (file server or authentication server) function and processing of the OCR function are realized by the common CPU 10a. However, a plurality of CPUs may be provided in the image forming apparatus 1, and the processing of the server function may be independently executed by one of the CPUs.

In general, in the early morning and night, processing for maintenance such as file synchronization is mostly executed. That is, the OCR function is not used very often, and access to the box and authentication request are more frequent.

Therefore, in the image forming apparatus 1A, the schedule update unit 105 may update the schedule data 51 such that the time zone extracted by the schedule collation unit 104 is a partial on-time zone, as indicated by thick frames and hatches in FIG. 17.

Then, the power source unit 10m, when it is the partial on-time zone, supplies power as usual to hardware modules necessary to provide a box function (for example, the above-described one of the CPUs and the auxiliary storage apparatus 10d). However, supply of power to other hardware modules (such as some or all of other CPUs, the touch panel display 10e, the operation key panel 10f, the modem 10h, the scan unit 10i, the image processing unit 10j, and the print unit 10k) is made to be paused.

After that, when it is the off-time zone, the power source unit 10m sets the specified time in the BIOS as described above. Alternatively, when it is the on-time zone, power is supplied to all hardware modules as usual.

In the present embodiment, the time zone of each day from Monday to Friday is divided for each one hour (60 minutes). That is, week days are divided into 120 time periods. However, another way of division may be used. For example, each day from Monday to Sunday may be divided for each of two hours (120 minutes). That is, one week may be divided into 84 time periods.

The image forming apparatus 1 may serve as both the master unit and the slave unit. In this case, the schedule data storage unit 101 only needs to serve as the schedule data storage unit 121. Then, the schedule transmission unit 123 only needs to read the schedule data 51 from the schedule data storage unit 101, and transmit the data as the schedule data 52 to the other image forming apparatuses 1. In addition, the schedule update unit 124 only needs to update the schedule data 51.

Besides, in the image processing system 4, image forming apparatus 1, the configuration of whole or each unit, the contents of the processing, the order of the processing, the configuration of data, and the like can be changed as appropriate in accordance with the spirit of the present invention.

Although embodiments of the present invention have been described and illustrated in detail, it is clearly understood that the same is by way of illustration and example only and not limitation, the scope of the present invention should be interpreted by terms of the appended claims.

What is claimed is:

1. An image processing apparatus in which first schedule data defines a first on-time zone during which a power source is turned on and an off-time zone during which the power source is turned off, and that switches on and off of the power source for at least a part of hardware modules of the image processing apparatus on the basis of the first schedule data, the image processing apparatus comprising
a hardware processor that:
acquires second schedule data defining a second on-time zone during which a power source of another apparatus is turned on, from the other apparatus that performs processing in cooperation with the image processing apparatus; and
updates the first schedule data such that the first on-time zone includes all or part of a time zone identical to the second on-time zone on the basis of the second schedule data.

2. The image processing apparatus according to claim 1, further comprising
a file server function, wherein
the hardware processor updates the first schedule data such that the first on-time zone includes a time zone during which the file server function is remotely used out of the time zone identical to the second on-time zone.

3. The image processing apparatus according to claim 1, further comprising
a specific processing function that executes specific processing, wherein
the hardware processor updates the first schedule data such that the first on-time zone includes a time zone during which the specific processing function is used out of the time zone identical to the second on-time zone.

4. The image processing apparatus according to claim 3, wherein
the specific processing function is processing that is performed in cooperation with the other apparatus via a communication line.

5. The image processing apparatus according to claim 3, wherein
the specific processing function is processing that authenticates the other apparatus accessing the image processing apparatus via a communication line or a user of the other apparatus.

6. The image processing apparatus according to claim 1, wherein
the hardware processor acquires the second schedule data at a predetermined time.

7. The image processing apparatus according to claim 1, wherein
the hardware processor acquires the second schedule data when the second schedule data is updated.

8. The image processing apparatus according to claim 1, wherein
the other apparatus includes a plurality of the other apparatuses,
the hardware processor acquires the second schedule data from each of the other apparatuses, and
the hardware processor updates the first schedule data such that the first on-time zone includes all or part of a time zone identical to the second on-time zone defined by at least one of the second schedule data.

9. An image processing apparatus that comprises a plurality of central processing units (CPUs), the image processing apparatus comprising
a storage that stores first schedule data defining a first on-time zone during which a power source is turned on and an off-time zone during which the power source is turned off, wherein
one of the plurality of CPUs
acquires second schedule data defining a second on-time zone during which a power source of another apparatus is turned on, from the other apparatus that performs specific processing in cooperation with the image processing apparatus, and
updates the first schedule data such that the first schedule data includes a time zone identical to the second on-time zone out of the off-time zone as a third on-time zone on the basis of the second schedule data, the image processing apparatus further comprising
a power supply that supplies power to all of the plurality of CPUs during the first on-time zone, and supplies power only to a part including a CPU used for the specific processing out of the plurality of CPUs during the third on-time zone on the basis of the first schedule data.

10. A non-transitory recording medium storing a computer readable program used for an image processing apparatus in which first schedule data defines a first on-time zone during which a power source is turned on and an off-time zone during which the power source is turned off, and that switches on and off of the power source for at least a part of hardware modules of the image processing apparatus on the basis of the first schedule data, the program causing the image processing apparatus to execute:
acquiring second schedule data defining a second on-time zone during which a power source of another apparatus is turned on, from the other apparatus that performs processing in cooperation with the image processing apparatus; and
updating the first schedule data such that the first on-time zone includes all or part of a time zone identical to the second on-time zone on the basis of the second schedule data.

11. A non-transitory recording medium storing a computer readable program used for an image processing apparatus that comprises a plurality of central processing units (CPUs) and controls supply of power on the basis of first schedule data defining a first on-time zone during which a power source is turned on and an off-time zone during which the power source is turned off, the program causing the image processing apparatus to execute:
acquiring second schedule data defining a second on-time zone during which a power source of another apparatus is turned on, from the other apparatus that performs specific processing in cooperation with the image processing apparatus;
updating the first schedule data such that the first schedule data includes a time zone identical to the second on-time zone out of the off-time zone as a third on-time zone on the basis of the second schedule data; and
supplying power to all of the plurality of CPUs during the first on-time zone, and supplying power only to a part including a CPU used for the specific processing out of the plurality of CPUs during the third on-time zone on the basis of the first schedule data.
